(19) United States
(12) Patent Application Publication
(10) Pub. No.: US 2017/0129269 A1
(43) Pub. Date: May 11, 2017

(54) AUTOMATED BOOK ASSEMBLY SYSTEM AND METHOD

(71) Applicant: Sasha Dobrovolsky, Nashville, TN (US)

(72) Inventor: Sasha Dobrovolsky, Nashville, TN (US)

(21) Appl. No.: 14/938,626

(22) Filed: Nov. 11, 2015

(51) Int. Cl. B42C 19/08; B42C 11/04; B42C 9/00; B65H 37/04; B42C 5/00

(52) U.S. Cl. CPC B42C 19/08; B65H 37/04; B42C 5/00; B42C 9/0006; B42C 11/04; B65H 2801/48

(57) ABSTRACT

A high-speed automated assembly system for printed products, especially suited, for example, for printing books on demand. More particularly, at least one robotic processing station, and separate book assembly processing sub-stations, replace a standard bindery equipment in order to improve system flexibility, speed and efficiency.

### BACKGROUND OF THE INVENTION

1. Field of the Invention

The present invention relates generally to a system and method for manufacturing printed products, such as books, and more particularly to an automated book assembly system and method.

2. Description of the Related Art

As discussed in U.S. Pat. No. 7,503,555, a book typically comprises a plurality of text pages stacked one upon the other (referred to as book block) and a cover overlying the front, back and spine of the book block. The book block is typically printed on thin, whereas the cover is typically printed in color and on paper which may be thicker or of higher quality. Books are generally mass produced by offset printing to ensure cheap manufacture and, after distribution all over the world, general accessibility. This traditional method requires the publishing industry to print a large number of copies (at least several hundreds, generally thousands), and, after the books are produced, to store, distribute and sell them to retailers. During production, the components like the book block and cover are produced separately off-line and joined later.

In recent years, book printing has undergone changes as computer technology and laser and inkjet printers have advanced. This new technology allows for machines capable of printing books with lower numbers of copies “on demand.” Historically, for “on demand” books, book blocks and covers are produced separately and manually inserted into a binder for binding or the books are printed and bound in in-line systems. Due to the manual handling of the components and/or the setup times of the equipment, low numbers of copies (down to one single copy) cannot be produced economically.

To overcome these issues, U.S. Pat. No. 7,503,555 and U.S. Patent Application Pub. No. 2007/0008587 disclose improved systems and methods for printing a book on demand. Specifically, the system of U.S. Pat. No. 7,503,555 includes a first printing unit for printing a first component, a second printing unit for printing a second component, a computer control system to initiate printing of the first component by the first printing unit, and receives a triggering signal and, after receipt of this triggering signal, initiates printing of the second component by the second printing unit, and a first buffer unit for buffering at least the first component at least until a corresponding second component is ready for binding. In this way, the printing system is no longer limited to “in line” linear operation by can print the components independently.

Furthermore, U.S. Patent Application Pub. No. 2007/0008587 discloses a system including a central transfer station in which the components are processed in a non-linear fashion to provide improved efficiency and redundancy over the traditional in-line systems. Specifically, a printed product is infed to the transfer station at the infeeding location and is transported in any sequence from the transfer station to one of the processing stations. After completion of the processing operation in a particular processing station, the printed product is moved back to the transfer station.

One of the traditional processing stations is known as a “binder” which is part of a binder line that both binds and trims a book to the final size. An example of a typical binder line is illustrated in FIG. 1. As disclosed in U.S. Pat. No. 8,950,994, U.S. Pat. No. 8,613,581 and U.S. Pat. No. 8,096,542 the prior art book binders use a fixed path to process the printed products. Traditionally, the binder is a stand-alone processing station that takes a book block, grinds it, glues it, and attaches a cover. The binder machines are generally quite expensive. All known binders process a book block and a cover on a fixed path. In other words, once a book block is loaded into the binder machine, each book block is processed in a clamp that travels along a linear track that is the same for each book block. The processing path may be a straight line, or in some devices an oval, circle, or straight line, but in all cases the book block must pass along a track in a fixed path. For example, FIGS. 2A-2C illustrate examples of typical tracks having a single path.

A typical clamp is illustrated in FIG. 3. A universal book block clamp needs to be able to handle books with various different thicknesses, from relatively thin books to relatively thick books. In addition, the book blocks may be of differences sizes. The clamp must be strong and rigid in order to hold the book block perfectly square, even when high torque forces are applied by the grinder and other processing steps. All clamps in a binder are able to adjust to the various books sizes and thicknesses with the specification of the binder, and still be able to securely hold the books, even with high torque forces and the necessary precision, in order to eliminate defects in the final book.

In high speed commercial binders, there are usually several book block clamps that process the block blocks along a linear track at the same time. The machines are typically set to run on a continuous drive. This fixed path and continuous drive, limits the ability to (1) adjust the machine for different settings; and (2) vary the amount the amount of time per station. U.S. Pat. No. 8,613,581 discloses a system that allows for the adjustment for the binder by skipping feeding book blocks in clamps to allow more time for the machine to adjust while running on a continuous path. Muller Martini's Vareo™ binder machine introduced in 2015 allows for the clamps to move at different speeds to optimize various steps, by having each clamp on its own servo motor. Illustrated in FIG. 3, the binder machine has three different “chains” to move the clamps. Each chain operates at a different speed in order to process different types of book blocks and optimize the amount of time at each processing station. In any event, the clamps are still on a fixed path and either capacity is lost (empty clamps), or the clamp can be slowed down for part of the cycle, but since the clamps are on the same rail, no clamp can run faster than another clamp for more than one cycle (which is usually only a matter of seconds).

After the book block is secured in a clamp, the book block is transferred to a grinder 50, where material is ground from the spine of the book block, as shown in FIG. 4. This insures that the spine of the book block contains all pages of the book block, even if the book block is not perfectly jogged (aligned along the edge). If the edge is not even, then the gluing process might not get glue on every sheet, and certain pages could later fall out of the book. This process may be skipped, if the stack is perfect and the book blocks are already glued together.

After the grinding step, the binder then moves the book block to a gluing unit 52 (FIG. 4) which applies an even coat of glue to the edge of the book block. The gluing unit also generally applies a thin strip of glue to each side of the book block, in order to better adhere the cover. The cover is typically scored to the size of the book block. Finally, the book block is sent to a combining unit, called a nipping station, which combines the book block with a cover and converts a flat sheet cover into a cover that wraps around the book block, with two ninety degree angles in the book. The finished unit is then removed from the binder.

However, in some circumstances, the book block and the cover may not match. This is especially true in situations where different books are printed in batches, such as the case in systems designed to print a “book on demand.” If the book block and cover do not match, most existing binder machines will simply put the wrong cover on the wrong book block. A few binder machines may merely alert a human operator, and the mis-matched set must be removed manually. Other machines may “dump” either a sequence of covers or book blocks until a match is found. Since the process is completely “in line,” there is no mechanism for handling these error conditions.

For many binders that are capable of short run production, the thicker the book block, the longer the grinding process will take, unless the binder machine has a very strong clamp and a very fast grinder. So, it is also difficult to improve the efficiency of the binder, if it will handle book blocks of varying thicknesses. Also, since the system process the book blocks in line, it is not easy to have different types of gluing stations available, for example, to use on type of glue for uncoated paperback books and a different (and generally more expensive) glue for textbooks with coated paper. Moreover, since the prior art binder machines process the book blocks along a fixed path, it is difficult to operate the binder machine at a sufficiently high rate of speed to accommodate high-speed printing operations involving mixed-sized books.

Similarly, if the grinding unit or gluing unit fails, the entire binder machine must be stopped and the faulty unit repaired.

In order to improve the speed and efficiency of book printing, it would be desirable to have an improved system for binding books in a high speed manufacturing environment.

### SUMMARY OF THE INVENTION

The present invention is a system for automated manufacturing especially suited, for example, for the bindery process in printing. In general, the present design allows for systems that were designed to only work with components along a fixed rail/path, to address these same components utilizing a computational control and a standard robotic workstation, for combining together parts that were designed to work on a fixed rail/path. The invention can use the processing components from current systems, or allow for the introduction of simpler components that generally will be less expensive, more reliable, and or can be optimized for superior product quality.

In another aspect, the present invention can also reconstruct components from more than one system that are typically sequential production steps but independent systems in the production process. More particularly, the present system replaces a standard binder machine with a robotic workstation, and separate processing sub-stations, in order to improve system speed and efficiency.

According to a first embodiment of the present invention, a processing system for processing printed products comprises at least one processing robot, and at least two processing sub-stations, wherein each processing sub-station performs a processing task on the first input printed product component, and wherein the processing robot can place the first input printed product component into the at least two processing sub-stations according to a pre-programmed order, and based on the pre-programmed order, a processing sequence for each printed product component can be unique.

According to another embodiment of the invention, an automated book assembly system comprises a book block input conveyor to convey book blocks for processing, a book cover input conveyor to convey book covers for processing, an output conveyor to convey finished books from the system, at least one processing robot, a gluing sub-station, and a nipping sub-station, wherein the at least one processing robot places and removes book blocks into the gluing station, and book covers and book blocks into the nipping station, according to a pre-programmed sequence, and places finished books onto the output conveyor.

In another embodiment, a method of binding a printed product in an automated binding system including a processing robot, comprises receiving a book block from a book block conveyor at the processing robot, the processing robot placing the book block into a first processing sub-station, processing the book block in the first processing sub-station, the processing robot removing the book block from the first processing sub-station, the processing robot placing the book block into a second processing sub-station, processing the book block in the second processing sub-station, the processing robot removing the book block from the second processing sub-station, and the processing robot placing the book block onto an output conveyor.

In another aspect of the present invention, an automated book assembly system comprises a book block conveyor to convey a book block to the system, a book cover conveyor to convey a book cover to the system, a processing robot to move the book block and cover from the conveyor and to and from processing sub-stations, a gluing sub-station that applies glue to a spine of the book block, a nipping station that combines the book block and the book cover to form a finished book, and an output conveyor that conveys the finished book out of the system.

An embodiment of an automated book assembly system comprises a book block conveyor to convey a book block to the system, a book cover conveyor to convey a book cover to the system, a processing robot to move the book block and cover from the conveyor and to and from processing sub-stations, a sewing sub-station that sews together the spine of the book block and/or signatures, a nipping station that combines the book block and the book cover to form a finished book, and an output conveyor that conveys the finished book out of the system.

In another embodiment, a method of binding a printed product in an automated binding system includes a processing robot directly taking a book block from a printer and/or the processing robot taking a cover directly from a cover printer. These variations would be instead of taking the book block or cover from a conveyor as described above.

An automated book assembly system according to one embodiment of the invention comprises at least two book production assembly lines, each assembly line comprising: at least two input conveyors to convey input printed products for assembly, at least one output conveyor to convey a finished book, and at least one processing robot, wherein the at least one processing robot from each production assembly line share a plurality of processing sub-stations, and each processing sub-station comprises a fixed book block clamp, and each processing robot places each input printed product into a processing sub-station according to pre-programmed sequence based on a specific type of printed product.

According to an aspect of the present invention, printed products may be processed without regard to a required fixed path through a binding machine. Particularly, a binding system for binding printed products comprises at least one processing robot, at least two book block processing sub-stations, and at least one nipping station to apply a book cover to a book block, wherein incoming book blocks are processed by the processing robot to the at least two book block processing sub-stations and the nipping station in a programmed order such that the book blocks are not processed in a fixed processing path.

According to another embodiment of the present invention, an automated book assembly system for combining a book block and a book cover, where the cover has a flap on one or both sides, the system comprises at least one processing robot, at least one trimming station; and at least one nipping station, wherein the processing robot places the book block in the at least one trimming station to trim a front of the book block, and then places the book block and book cover into the nipping station for attachment with the one or more flaps of the cover closed, and the places the combined book block and book cover back into the trimming station to trim the top and bottom of the book.

A method, according to the present invention, of binding a printed product in an automated binding system including a processing robot, the printed product including a book block and a book cover, where the cover has at least one flap, the method comprises receiving a book block at the processing robot, the processing robot placing the book block in a trimming station, the trimming station trimming a front of the book block, the processing robot moving the book block to a nipping station and also placing a book cover in the nipping station, the nipping station combining the book block and the book cover, wherein the at least one book cover flap is closed, the processing robot moving the combined book block and book cover to the trimming station, the trimming station trimming a top and bottom of the combined book block and book cover; and the processing robot removing the combined book block and book cover from the trimming station.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a prior art binding machine;

FIGS. 2A-2C illustrate various fixed tracks inside typical prior art binding machines;

FIG. 3 illustrates three separate chains for moving a clamp at different speeds according to a prior art binding machine;

FIG. 4 illustrates a grinding and gluing station inside a typical prior art binding machine;

FIG. 5 illustrates a first embodiment of a book assembly system according to the present invention;

FIG. 6 illustrates an alternative embodiment of a book assembly system according to the present invention; and

FIG. 7 illustrates another embodiment of a book assembly system according to the present invention.

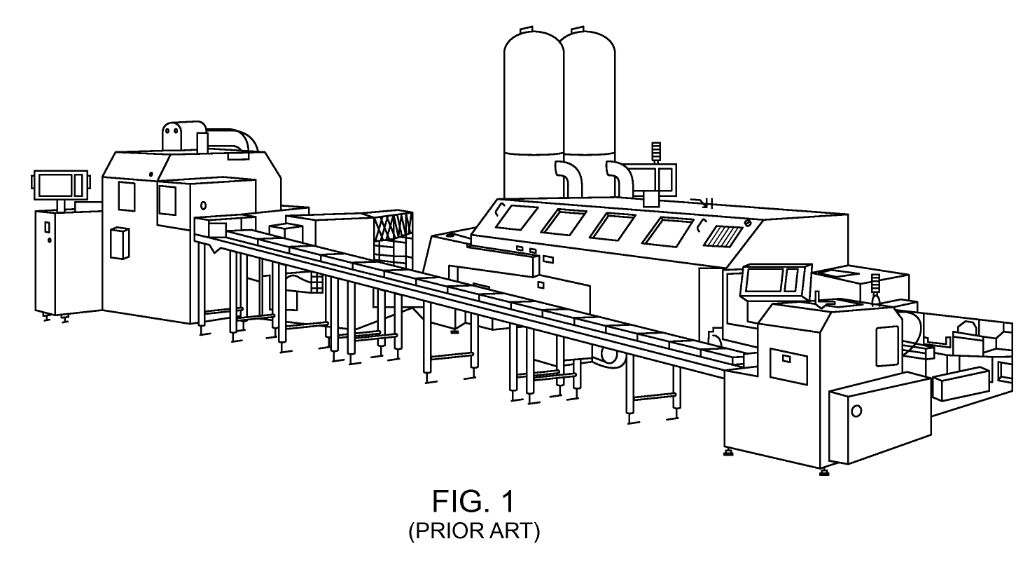

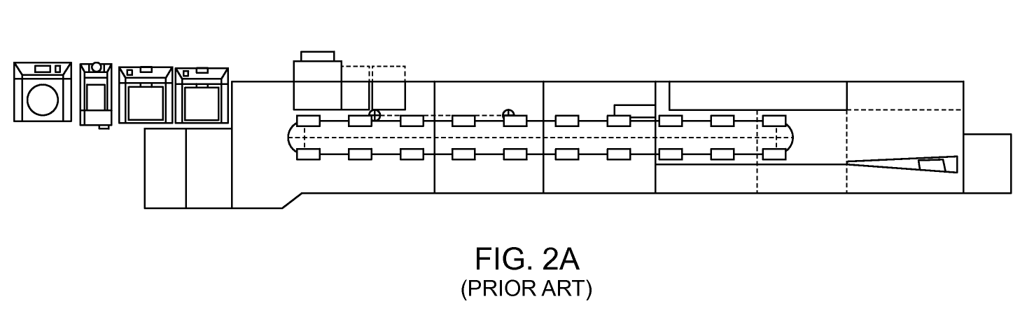

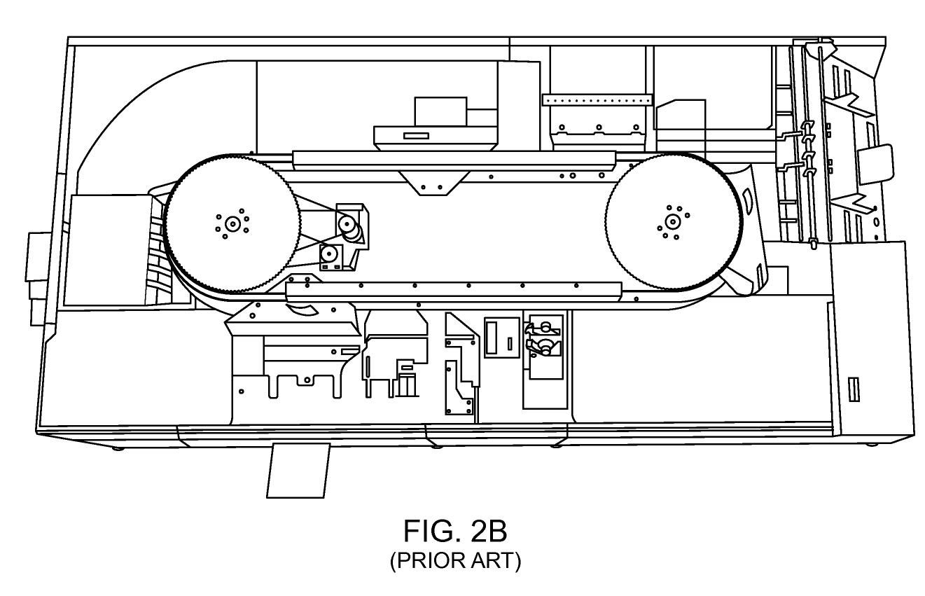

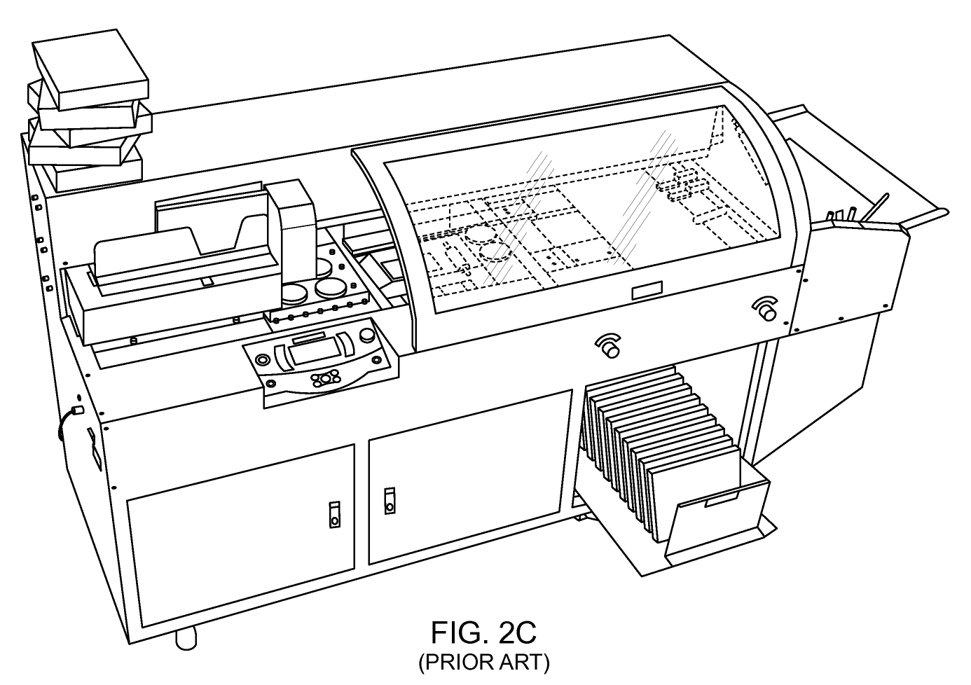

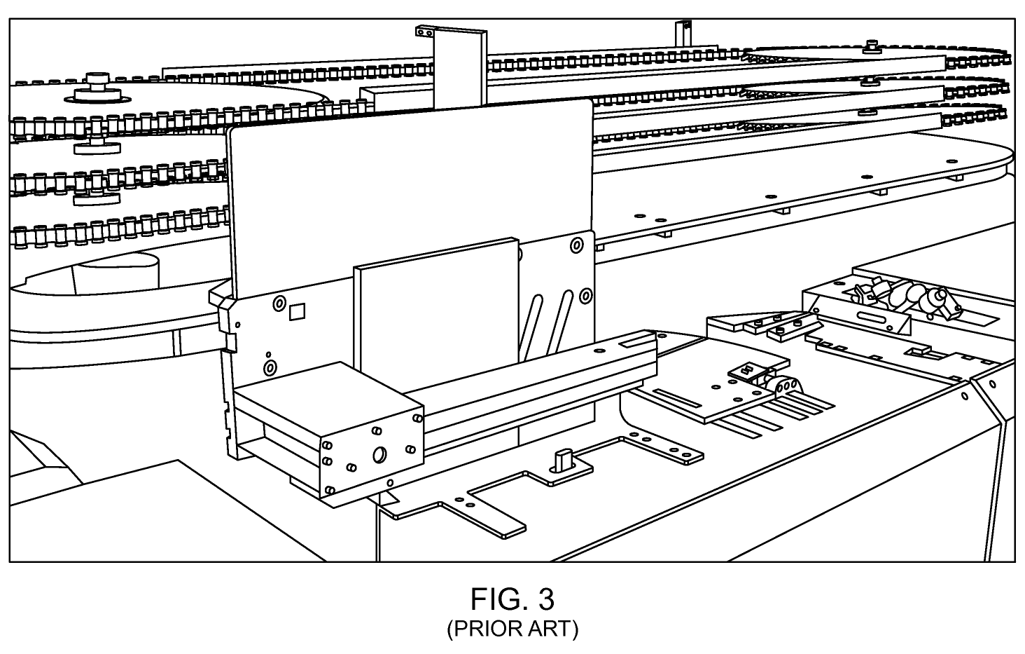

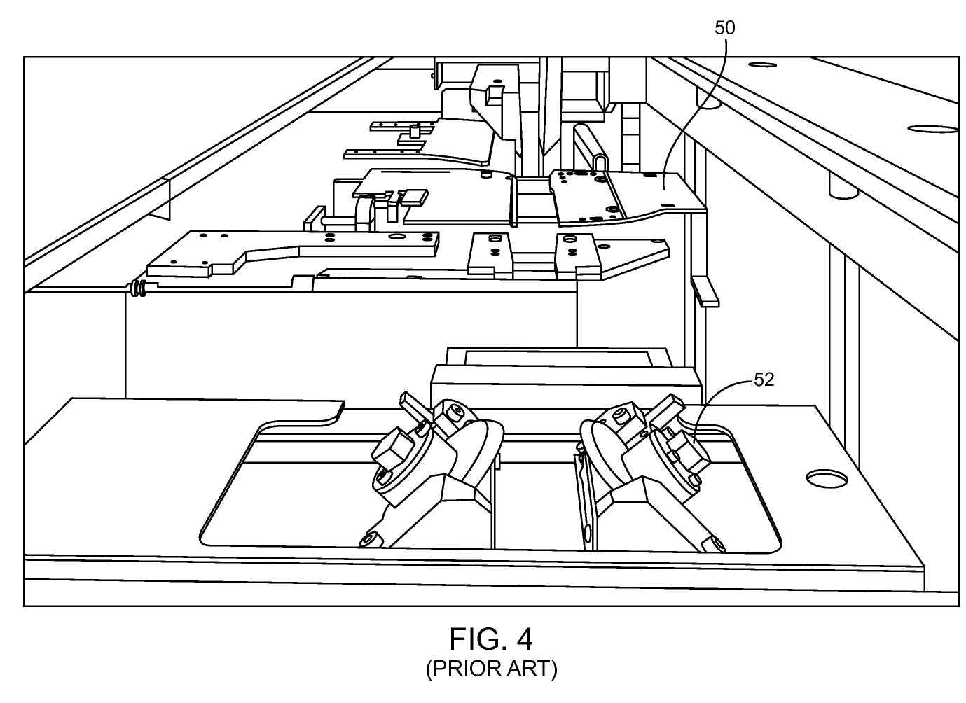

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art. Any and all such modifications, equivalents and alternatives are intended to fall within the spirit and scope of the present invention.

The present invention is a system for high-speed automated binding especially suited, for example, for printing books on demand. More particularly, the present system replaces a standard binder machine with a robotic workstation, and separate processing sub-stations, in order to improve system speed and efficiency. The present system can also replace a standard binder and book trimmer, or other finishing devices with a robotic workstation and separate processing sub-stations.

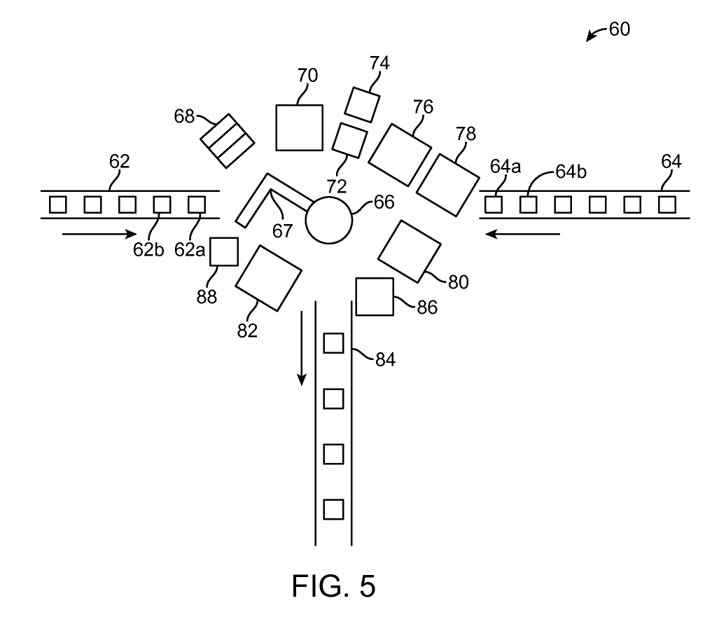

An embodiment of the present invention is illustrated in FIG. 5. This figure is used to describe the basic concept of the present invention, but the present invention may be implemented using more or less components, as needed for a particular application. Specifically, the processing system 60 includes a book block conveyor 62, which delivers book blocks 62a, 62b for processing. Note that each book block may be of a different size and a different thickness. Similarly, a cover conveyor 64 delivers covers 64a, 64b for attachment to the book blocks 62a, 62b, respectively. Again, the covers may each be unique, depending on the requested item to be printed.

A processing robot 66 handles the book blocks 62a, 62b and covers 64a, 64b coming off the conveyor systems 62, 64. The processing robot 66 is an automated, programmable robot including a robotic arm 67, as is known in the art for use in automated manufacturing environments. For example, the processing robot 66 may be a Kuka KR 10 R1100 sixx (KR AGILUS)™ robot arm available from Kuka Roboter GmbH. Any other similar programmable processing robot with a robotic arm may be used. The processing robot can place the input printed product component into the processing sub-stations according to a pre-programmed order, and based on the pre-programmed order, a processing sequence for each printed product component can be unique

In operation, the processing robot 66 removes a book block 62a from the book block conveyor 62. The processing robot 66 then checks to see if the book block 62a matches the cover 64a arriving on the cover conveyor 64. This can be done, for example, by receiving an identification signal from a main processing computer (not shown) identifying each element on the conveyors, by bar codes stamped on the book block 62a and cover 64a, by RFID tags on each element, or other similar identification methods used in manufacturing environments.

If the book block 62a does not match the cover 64a, the processing robot 66 places the book block 62a into a storage shelf 68. This allows the system to operate in an automated fashion, since a mis-match error does not require human intervention and does not waste mis-matched components. Moreover, if the correct cover for the stored book block arrives on the cover conveyor 64, the processing robot 66 can remove the matching book block from the storage shelf 68 and continue processing.

According to the present invention, since there can be multiple processing stations, each processing station can have a heavy-duty “fixed clamp.” In other words, since the clamp does not need to move along a processing track, the clamp can be affixed more rigidly to a processing station. This allows the clamp to more securely hold each book block. In addition, there can be multiple fixed clamps of different sizes in each processing station to improve quality and efficiency.

If the book block 62a does match the cover 64a, then the processing robot 66 may place the book block into a cutter machine 88 (“trimmer” or “trimming station”). The cutter machine 88 cuts the so-called head, face and foot of the book block (each edge other than the “spine”). In prior art book processing systems, it is difficult to create a single clamping mechanism that can clamp varied sizes and thicknesses of book blocks for cutting. However, since the present invention does not process the book blocks along a fixed track, the cutter machine 88 may contain multiple clamps of various sizes in order to securely clamp different sized book blocks. Alternatively, there can be multiple cutter machines 88, each optimized for different sizes of book blocks.

The processing robot can also be used to bring various clamps, pads, jigs, or other specific tools to a processing station. For example, for a small book the processing robot could take and or insert a small pad and or an optimized clamp to a cutting station in order to trim a small book with optimized quality and efficiency. Either the same or a different processing robot can then insert this book into the trimmer that has been optimized for this book size. When a large book is present at the trimmer, the same processing robot can bring a large pad and or optimized clamp to the trimmer. The same process would follow, with the book being inserted into a trimmer that has been optimized for this particular size book. Multiple pads, clamps and other inserts of different sizes can be stored on shelves or on the floor of the system.

Next, the processing robot 66 may place the book block 62a into a notching unit 70, if necessary. A notching unit 70 makes a series of “cuts” or notches across the spine of the book block. For some processes, this provides better glue adherence by creating notches for additional glue in the spine. Depending on the desired process, a book block may only be notched, or only grinded, or both. Since in the present invention, the notching station 70 is not tied to a fixed processing track, the notching station 70 may have a fixed clamp and the orientation of the book block may be configured to reduce the chances of the book block slipping in the clamp while it is being notched.

Next, the book block 62a is moved to a grinding station 72 to remove any excess material from the book block as necessary. In a standard binder machine, there is a single grinder station. Since thicker book blocks take longer to grind than thin book blocks, the processing time is not necessarily the same from book block to book block. However, in the present system, there can be multiple grinder stations, if required.

For example, a system could have two or more grinder stations 72, 74 to increase the speed of the system, by allowing multiple book blocks to be processed at the same time. Also, each grinder station 72, 74 could be optimized to process book blocks of different thicknesses, thereby improving the quality and speed of the grinding process. For example, some grinder stations may be slowed down to provide greater accuracy for certain types of book blocks, while other grinder stations may operate at a higher speed. Furthermore, each grinder 72, 74 could have a clamp designed to handle a certain range of thicknesses, and/or each grinder 72, 74 could have multiple specialized clamps, each optimized for different thicknesses. Also, if one grinder station 72, 74 is down for repairs, the entire system can still operate. In contrast, if the grinder in the unitary binders of the prior art failed, the entire system would have to be halted.

In an alternate embodiment, the paper sheets of the book blocks 62a, 64a may be glued together upon input into the printing system. For many applications, this would eliminate the need for a separate grinding step, since the pages are already aligned. Also, this alleviates the need for a strong clamp to handle the book blocks, as is done in prior art binders, since the primary need for the clamp is hold the book block securely in a grinder station. In this embodiment, the book block 62a is simply glued to the cover 64a, without the need for a grinder. This greatly simplifies the entire printing and binding operation.

Depending on the customer requirements for the type of paper, the processing robot 66 may place the book block 62a into a notching unit 70, if necessary. A notching unit 70 makes a series of “cuts” or notches across the spine of the book block. For some processes, this provides better glue adherence by creating notches for additional glue in the spine. Depending on the desired process, a book block may only be notched, or only grinded, or both. Since in the present invention, the notching station 70 is not tied to a fixed processing track, the notching station 70 may have a fixed clamp and the orientation of the book block may be configured to reduce the chances of the book block slipping in the clamp while it is being notched.

After grinding the book block 62a, if required, the processing robot 66 moves the book block 62a to the gluing station 76. As in a standard binder, the gluing station applies glue to the edge of the book block 62a, and also generally applies a thin strip of glue to each side of the book block 62a in order to adhere the cover 64a to the book block 62a.

There may be multiple gluing stations 76, 78 available to the processing robot 66. Having multiple stations provides system redundancy, and also provides a way to have different types of glue available, depending on the requirements of each individual book block.

For case bound books and other applications, a strip of “cloth” is attached to the glued spine before the cover is attached. The cloth strip helps hold the book block together until the cover is attached. This step is performed at a clothing station 86.

Finally, for non-case bound books, the processing robot 66 moves the book block 62a and the cover 64a to a combining unit, called a nipping station 80, 82. The nipping station 80, 82 combines the book block with a cover and converts a flat sheet cover into a cover that wraps around the book block, with two ninety degree angles in the book. The book block 62a and the corresponding cover 64a are combined, and the finished book is moved to the output conveyor 84.

As described, the present invention overcomes many of the limitations of the prior art book binder machines. Specifically, the book block processing is no longer limited to a fixed path, in-line processing method. The book blocks and corresponding covers may arrive out of order, but can still be combined in an automated fashion. In addition, because the processing robot 66 can move the book blocks to different processing units in different orders (change the processing sequence or re-order the processing), or skip certain units altogether, the processing efficiency is improved. Also, since there can be multiple processing units, such as multiple grinders, gluing units, and/or cover insert stations, the efficiency and speed of the book binding process can be increased by having multiple book blocks be processed in parallel.

The present invention also overcomes the problem associated with the variable time it takes the processing unites to notch, grind, glue, and/or combine, depending on the size and thickness of the book blocks. Since the processing robot can select from multiple devices, book blocks can be processed by processing units optimized and/or specialized for processing each type of book block. In addition, since the processing is not limited to a fixed track, book blocks can be processed in parallel.

It should be noted that while the embodiments herein have been described using “conveyors” to convey printed product components into and out of the system, other mechanisms may be used. For example, the processing robot may receive input components from racks and/or shelves and similarly place finished components into racks and/or shelves.

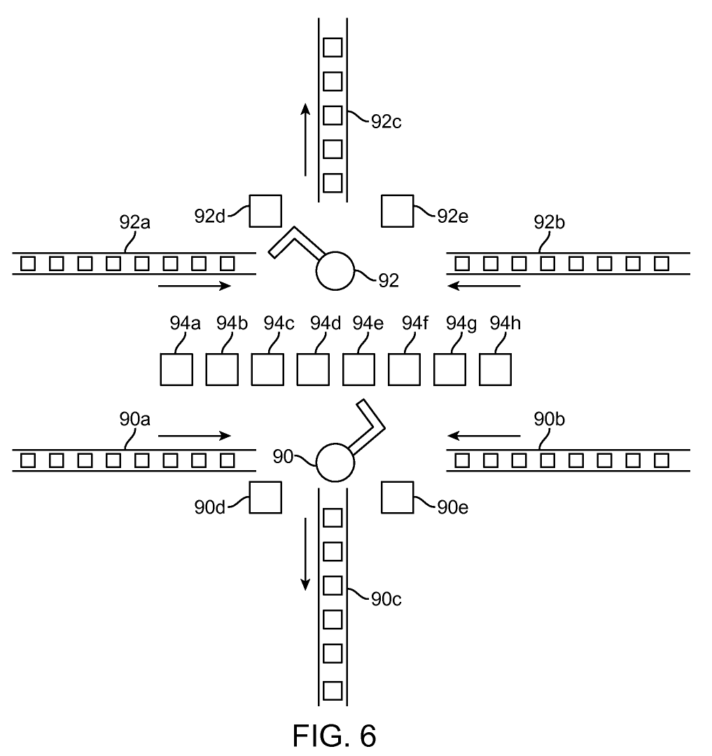

An alternative embodiment of the present invention is illustrated in FIG. 6. In this embodiment, two processing robots, 90, 92 may each have their own input 90a, 90b, 92a, 92b and output conveyors 90c, 92c. However, the processing robots may share multiple processing units 94a-94h. The processing units may include, for example, notching units, grinders, gluing units, and combiners. By sharing certain processing units, system efficiency can be improved, especially for any specialized processing units that may have limited use. In addition, this provides greater system redundancy by allowing multiple processing units of a single type (grinder, gluing unit, etc.) to be shared among processing robots.

In this embodiment, each processing robot 90, 92 may also have dedicated processing units 90d, 90e, and 92d, 92e, respectively. Of course, as can readily be appreciated, the number and types of processing units that are shared and/or are separate can be configured as desired to meet the needs of any particular book printing environment.

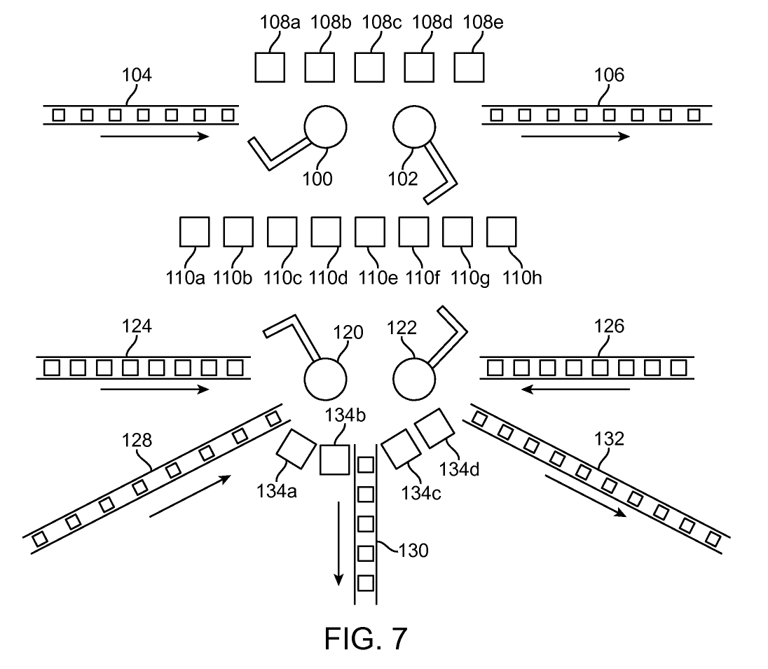

Another embodiment of the present invention is illustrated in FIG. 7. In this embodiment, there are again two different processing lines. The two processing lines again share a common set of processing stations 110a-110h. However, in the first line, there is only one input conveyor 104 and one output conveyor 106, and two processing robots 100, 102. In this embodiment, the two processing robots can operate in coordination in order to place and remove book blocks and/or covers from the input conveyor 104. Note that the book blocks from the input conveyor are still processed in sequence, but with multiple processing robots 100, 102 and multiple processing stations 108a-108e and 110a-110h, the overall throughput of the system can be increased.

For example, in a system with only one input conveyor, the system may include a storage bin that stores pre-printed covers, or may have a cover printer that prints a cover for each book block. For some application, it is possible that all book blocks, regardless of content, are fitted with a generic cover, and it may be more efficient to store the covers in a storage bin, rather than deliver them by a conveyor.

Similarly, the second processing line includes two processing robots 120, 122. However, in this processing line, there are three input conveyors 124, 126, 128 and two output conveyors 130, 132. Since the book blocks and/or covers arrive in sequence, the purpose of the multiple processing robots is to improve efficiency and throughput for a single processing line. If additional capacity is needed, then an additional processing line can be added to create true parallel capability.

The present invention has been described herein as a book assembly system that “glues” books together. However, while it is no longer as common, some books are “loose leaf,” and in the present invention, the book block can be drilled if required, and trimmed to create a book block. In either case, the present invention greatly improves the speed, efficiency and flexibility of the book binding process.

According to another embodiment, the present invention can process book cover have a “flap” on one or both sides. In this embodiment, the book block is either glued before entering the system, or does not require grinding. The book block is first placed in a trimmer sub-station by the processing robot to trim the front of the book block. The book block is then moved to a nipping sub-station along with the cover. The one or more flaps of the book cover are closed. The nipping sub-station combines the book block and the book cover. The processing robot then moves the combined book block and block back to the trimmer sub-station, or to a different trimmer sub-station. The top and bottom of the combined book block and cover is then trimmed in the trimmer sub-station, and finally, the finished product is removed from the system.

In the prior art binder machines, the “uptime” for the best machines is conditional on all the subsystems working at the same time. However, these monolithic machines are quite expensive. According to the present invention, by “deconstructing” the binding machine and removing the fixed processing track, each sub-processing station can be optimized and multiple sub-processing stations can be used in parallel, or in the alternative, as needed. This greatly increases the “uptime” of the over-all printing system and reduces the costs associated with purchasing multiple expensive binder machines.

Those skilled in the art will appreciate that various adaptations and modifications of the just described preferred embodiments can be configured without departing from the scope and spirit of the invention. Therefore, it is to be understood that, within the scope of the appended claims, the invention may be practiced other than as specifically described herein.

What is claimed is:

1. A processing system for processing printed products, the system comprising:
at least one processing robot; and
at least two processing sub-stations, wherein each processing sub-station performs a processing task on the first input printed product component;
wherein the processing robot can place the first input printed product component into the at least two processing sub-stations according to a pre-programmed order, and based on the pre-programmed order, a processing sequence for each printed product component can be unique.

2. The processing system of claim 1, further comprising:
at least one input conveyor to convey a first input printed product component; and
at least one output conveyor to convey a first output printed product component;
wherein the at least one processing robot removes a first input printed product component from the at least one input conveyor, and places a first output printed product component onto the at least one output conveyor.

3. The processing system of claim 1, wherein the at least two processing stations comprise a gluing station and a nipping station.

4. The processing system of claim 3, wherein the first printed product component comprises a book block.

5. The processing system of claim 4, wherein each of the at least two processing sub-stations comprise at least one fixed book block clamps.

6. The processing system of claim 4, wherein each of the at least two processing sub-stations comprise a plurality of fixed book block clamps.

7. The processing system of claim 4, further comprising a grinder sub-station.

8. The processing system of claim 4, further comprising at least processing sub-station shared with at least one processing robot of a separate printed product processing line.

9. The processing system of claim 1, wherein the processing robot can place a first book block into a first processing sub-station and a second book block into a second processing sub-station such that the first and second book blocks are processed at the same time.

10. The processing system of claim 1, further comprising a bin to store printed product components for access by the processing robot.

11. The processing system of claim 1, wherein each sub-station comprises a plurality of book block clamps of different sizes.

12. The processing system of claim 1, wherein each processing sub-station comprises a book block clamp, such that the book block clamps are of different sizes in at least two processing sub-stations.

13. The processing system of claim 1, wherein the processing robot places a clamp, pad or jig into a processing sub-station before placing a book block into the sub-station.

14. An automated book assembly system comprising:
a book block input conveyor to convey book blocks for processing;
a book cover input conveyor to convey book covers for processing;
an output conveyor to convey finished books from the system;
at least one processing robot;
a gluing sub-station;
a nipping sub-station;
wherein the at least one processing robot places and removes book blocks into the gluing station, and book covers and book blocks into the nipping station, according to a pre-programmed sequence, and places finished books onto the output conveyor.

15. The automated book assembly system of claim 14, further comprising a grinder sub-station.

16. The automated book assembly system of claim 15, wherein the grinder sub-station and the gluing sub-station each comprise a fixed book block clamp.

17. The automated book assembly system of claim 14, further comprising a plurality of processing sub-stations shared with at least one other processing robot of a separate book assembly processing line.

18. The automated book assembly system of claim 14, further comprising at least two grinder sub-stations and at least two gluing sub-stations.

19. The processing system of claim 14, wherein each sub-station comprises a plurality of book block clamps of different sizes.

20. The processing system of claim 14, wherein each processing sub-station comprises a book block clamp, such that the book block clamps are of different sizes in at least two processing sub-stations.

21. The processing system of claim 14, wherein the processing robot places a clamp, pad or jig into a processing sub-station before placing a book block into the sub-station.

22. A method of binding a printed product in an automated binding system including a processing robot, the method comprising:
receiving a book block;
the processing robot placing the book block into a first processing sub-station;
processing the book block in the first processing sub-station;
the processing robot removing the book block from the first processing sub-station;
the processing robot placing the book block into a second processing sub-station;
processing the book block in the second processing sub-station; and
the processing robot removing the book block from the second processing sub-station.

23. The method of claim 22, wherein the processing robot receives the book block from a book block conveyor; and
the processing robot places a finished book block onto an output conveyor.

24. The method of claim 22, wherein the first processing sub-station is a grinder sub-station that grinds a spine of the book block to create a smooth edge.

25. The method of claim 24, wherein the second processing sub-station is a gluing sub-station that applies glue to the spine of the book block.

26. The method of claim 25, further comprising;
receiving a book cover from a cover conveyor at the processing robot.

27. The method of claim 26, further comprising:
combining the book block and the cover at a nipping sub-station before the book block is placed on the output conveyor.

28. The method of claim 27, further comprising:
the processing robot placing the book block in a clothing sub-station to apply a cloth to the spine of the book block, before the book block is transferred to the nipping sub-station.

29. The method of claim 22, wherein the processing robot places a clamp, pad or jig into a processing sub-station before placing a book block into the sub-station.

30. An automated book assembly system comprising:
a book block conveyor to convey a book block to the system;
a book cover conveyor to convey a book cover to the system;
a processing robot to move the book block and cover from the conveyor and to and from processing sub-stations;
a gluing sub-station that applies glue to a spine of the book block;
a nipping station that combines the book block and the book cover to form a finished book; and
an output conveyor that conveys the finished book out of the system.

31. The automated book assembly system of claim 30, wherein the book block is glued together before it enters the system, such that a separate grinder sub-station is not needed.

32. An automated book assembly system comprising:
a book block conveyor to convey a book block to the system;
a book cover conveyor to convey a book cover to the system;
a processing robot to move the book block and cover from the conveyor and to and from processing sub-stations;
a sewing sub-station that sews together the spine of the book block;
a nipping station that combines the book block and the book cover to form a finished book; and
an output conveyor that conveys the finished book out of the system.

33. The automated book assembly system of claim 32, wherein the book block is glued together before it enters the system, such that a separate grinder sub-station is not needed.

34. An automated book assembly system comprising:
at least two book production assembly lines, each assembly line comprising:
at least two input conveyors to convey input printed products for assembly;
at least one output conveyor to convey a finished book; and
at least one processing robot;
wherein the at least one processing robot from each production assembly line share a plurality of processing sub-stations, and each processing sub-station comprises a fixed book block clamp, and each processing robot places each input printed product into a processing sub-station according to pre-programmed sequence based on a specific type of printed product.

35. A binding system for binding printed products comprising:
at least one processing robot;
at least two book block processing sub-stations; and
at least one nipping station to apply a book cover to a book block;
wherein incoming book blocks are processed by the processing robot to the at least two book block processing sub-stations and the nipping station in a programmed order such that the book blocks are not processed in a fixed processing path.

36. An automated book assembly system for combining a book block and a book cover, where the cover has a flap on one or both sides, the system comprising:
at least one processing robot;
at least one trimming station; and
at least one nipping station;
wherein the processing robot places the book block in the at least one trimming station to trim a front of the book block, and then places the book block and book cover into the nipping station for attachment with the one or more flaps of the cover closed, and the places the combined book block and book cover back into the trimming station to trim the top and bottom of the book.

37. A method of binding a printed product in an automated binding system including a processing robot, the printed product including a book block and a book cover, where the cover has at least one flap, the method comprising:
receiving a book block at the processing robot;
the processing robot placing the book block in a trimming station;
the trimming station trimming a front of the book block;
the processing robot moving the book block to a nipping station and also placing a book cover in the nipping station;
the nipping station combining the book block and the book cover, wherein the at least one book cover flap is closed;
the processing robot moving the combined book block and book cover to the trimming station;
the trimming station trimming a top and bottom of the combined book block and book cover; and
the processing robot removing the combined book block and book cover from the trimming station.
